(19) United States
(12) Patent Application Publication
(10) Pub. No.: US 2005/0045782 A1
(43) Pub. Date: Mar. 3, 2005

(54) Display apparatus

(75) Inventors: Kyung-kyun Lee, Seoul City (KR); Kwang-sung Hwang, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/926,947

(22) Filed: Aug. 27, 2004

(30) Foreign Application Priority Data
Aug. 28, 2003 (KR) 2003-59911

(51) Int. Cl. F16M 13/00

(52) U.S. Cl. 248/158; 248/917; 248/176.1

(57) ABSTRACT

A display apparatus having a display body forming a picture, including a base supporting the display body, a stand provided between the display body and the base, and an external cover provided to be removable selectively on a top of the base. The present invention may prevent an increase of the price of the product caused by the expense for developing the new design by providing various appearances according to the user's preference. Also, the protrusion and the protrusion combining part enable the user to remove the external cover from the base easily.

### CROSS-REFERENCE TO RELATED APPLICATIONS

This application claims the benefit of Korean Patent Application No. 2003-059911, filed Aug. 28, 2003, in the Korean Intellectual Property Office, the disclosure of which is incorporated herein by reference.

### BACKGROUND OF THE INVENTION

1. Field of the Invention

The present invention relates to a display apparatus, and more particularly, to a display apparatus having a base with an improved appearance.

2. Description of the Related Art

Generally, a display apparatus refers to an apparatus, which displays a picture such as a TV or a monitor of a computer. The display apparatus comprises a display body forming the picture and a base supporting the display body.

The display body generally forms the picture by using a device such as, but not limited to, a CRT (cathode ray tube), an LCD (liquid crystal display), and a PDP (plasma display panel). Recently, the display bodies using the LCD or the PDP are being developed because of an advantage that they provide a wide displaying area while requiring less space.

The base, supporting the display body, is placed on an installation surface such as a table.

Recently, various sizes and appearances of the display apparatus have been developed according to customer's preference.

However, additional expenses are required in designing various exterior parts for the display apparatus to satisfy the customer's preference. Accordingly, the fact that a conventional display apparatus does not provide a removable exterior part because the expense of developing a new design of the exterior part increases a price of a product is disadvantageous.

### SUMMARY OF THE INVENTION

Accordingly, an aspect of the present invention provides a display apparatus provided with an exterior part removable selectively according to customer's preference.

The foregoing and/or other aspects of the present invention are achieved by providing a display apparatus having a display body forming a picture, comprising a base supporting the display body, a stand provided between the display body and the base, and an external cover provided to be removable selectively on a top of the base.

According to another aspect of the invention, a protrusion is provided at least on one of the base and the external cover, while a protrusion combining part combining with the protrusion is provided on the other of the external cover and the base.

According to another aspect of the invention, the base is shaped like a disk, and the external cover is shaped like the base to cover up the top of the base.

According to another aspect of the invention, the external cover comprises a skirt bent from an edge of the surface of the external cover to cover at least a part of a side of the base.

According to another aspect of the invention, the protrusion is formed on the skirt of the external cover toward the base. The protrusion combining part comprises a protrusion accommodating part depressed on an edge of the base to accommodate the protrusion, and a slot provided on a side of the protrusion accommodating part to prevent the protrusion accommodated in the protrusion accommodating part from deviating by inserting slidingly the protrusion into the slot.

According to another aspect of the invention, the protrusion and the protrusion combining part each are provided plurally to be spaced from each other.

According to another aspect of the invention, the base is shaped like a disk, and the external cover is shaped like the base to cover the top of the base.

According to another aspect of the invention, the external cover comprises a skirt bent from an edge of the surface of the external cover and covering at least a part of a side of the base.

According to another aspect of the invention, the protrusion is formed on the skirt of the external cover toward the base. The protrusion combining part comprises a protrusion accommodating part depressed on an edge of the base to accommodate the protrusion, and a slot provided on a side of the protrusion accommodating part to prevent the protrusion accommodated in the protrusion accommodating part from deviating by inserting slidingly the protrusion into the slot.

According to another aspect of the invention, a rear of the external cover is provided with a boss to be combined with the base by a screw.

According to another aspect of the invention, the external cover is made of material containing aluminum.

Additional and/or other aspects and advantages of the invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following description of the embodiments, taken in conjunction with the accompany drawings of which:

FIG. 1 is a perspective view of a display apparatus according to a first embodiment of the present invention;

FIGS. 2 and 3 are exploded perspective views of the display apparatus in FIG. 1;

FIGS. 4 and 5 are combined perspective views of a protrusion of the display apparatus combining with a protrusion combining part in FIG. 3;

FIGS. 6 and 7 are exploded perspective views of a display apparatus according to a second embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

A display apparatus according to an embodiment of the present invention refers to an apparatus forming a picture using a CRT (cathode ray tube), an LCD (liquid crystal display), and/or a PDP (plasma display panel) such as a TV, or a monitor of a computer.

Hereinbelow, the present invention will be described in reference to drawings of a display apparatus having a thin display body such as an LCD or a PDP as an example.

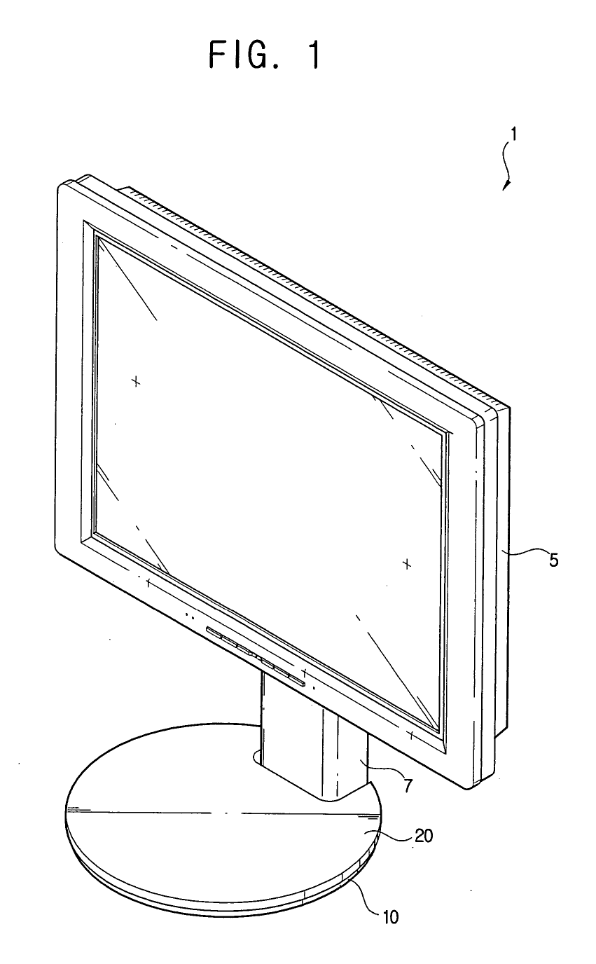

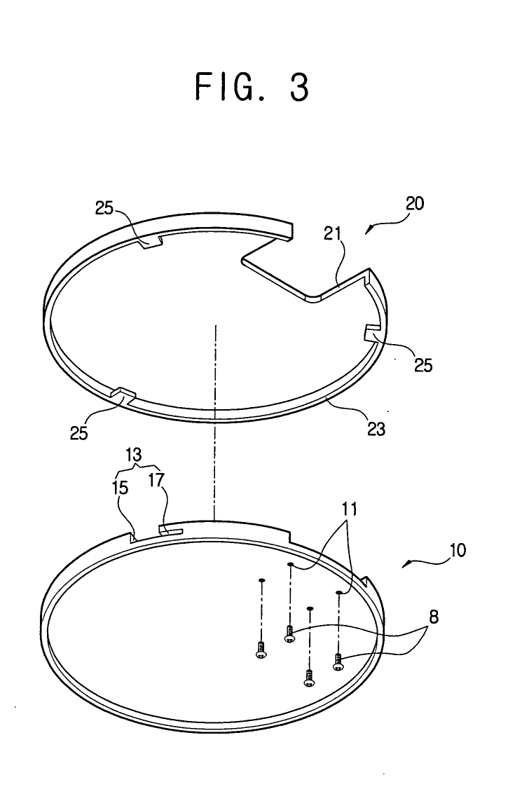

As illustrated in FIGS. 1 through 3, a display apparatus 1 according to the first embodiment of the present invention comprises a display body 5 forming a picture, a base 10 supporting the display body 5, a stand 7 provided between the display body 5 and the base 10, and an external cover 20 provided on a top of the base to be removable according to a user's preference.

The display body 5 is installed with a thin display panel such as an LCD or a PDP to display the picture. Also, the display body 5 is combined with an upper part of the stand 7. The display body 5 may tilt frontward and backward relative to the stand 7 by a hinge (not shown) provided between the display body 5 and the stand 7.

The stand 7 is shaped like a rod having an upper part combined to the display body 5 and a lower part combined to the base 10.

The base 10 is placed on an installation surface such as a table and supports the display body 5 once the display body 5 is combined to the lower part of the stand 7. Meanwhile, in an embodiment of the invention, the base 10 is shaped like a disk. Herein, a top of the base 10 is provided with a stand combining part 11, which may be plural in number, to screw-combine with the lower part of the stand 7 by a screw(s) 8. Also, the base 10 is formed with a protrusion combining part 13 to combine with a protrusion 25 of the external cover 20.

In an embodiment of the invention the external cover 20 is large enough to cover the base 10, and is removably combined on the top of the base 10. Meanwhile, the external cover 20 is shaped like the disk as the base 10, and comprises a protrusion 25 to be combining with the protrusion combining part 13 of the base 10. Also, the external cover 20 preferably comprises a skirt 23, bent from an edge of the surface of the external cover 20, to cover at least a part of a side of the base 10. Also, the external cover 20 is designed to take various appearances to enable the customer to install the external cover 20 selectively according to his or her preference.

The skirt 23 is bent from the edge of the external cover 20 downward while the protrusion 25 is formed on an end of the edge of the external cover 20.

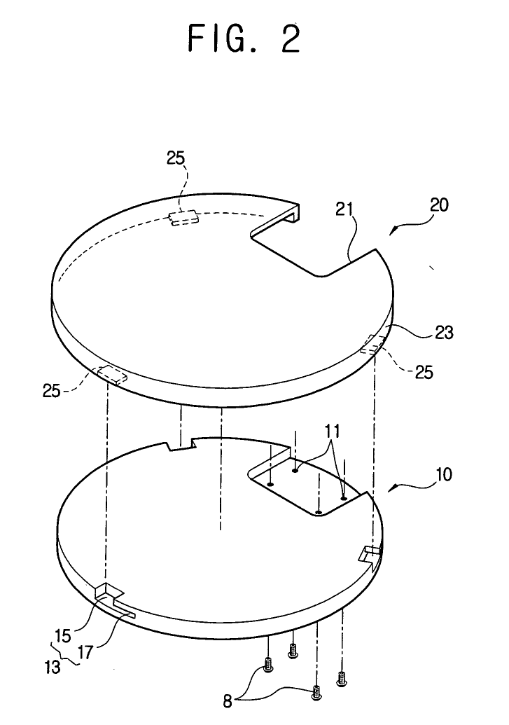

The protrusion 25 protrudes from the skirt 23 of the external cover 20 toward the base 10. In other words, the protrusion 25 protrudes from the end of the skirt 23 toward a center of the external cover 20 with a predetermined length. Also, the predetermined length of the protrusion 25 is set to be long enough for the protrusion 25 not to deviate easily from a slot 17 of the protrusion combining part 13 once the protrusion 25 is inserted. The protrusion 25 is provided plurally, such that the protrusions 25 are spaced from each other corresponding to the number of the protrusions 25. Meanwhile, an embodiment of the present invention, as shown in FIG. 2, includes three protrusions 25 being spaced from each other at a substantially constant interval, and three protrusion combining parts 13 in positions that correspond to the positions of the protrusions 25.

The protrusion combining part 13 comprises a protrusion accommodating part 15 depressed on an edge of the base 10 to accommodate the protrusion 25, and the slot 17, provided on one side of the protrusion accommodating part 15, to prevent the protrusion 25, inserted slidingly, from deviating. Accordingly, the protrusion combining part 13 is provided in equal number to correspond to the number of the protrusions 25. That is, if there are three (3) protrusions 25, the base 10 includes three (3) protrusion accommodating parts 15, each being substantially 1200 apart. Similarly, in an embodiment of the invention having four (4) protrusions 25, the base 10 includes four (4) protrusion accommodating parts 15, each being substantially 90° apart.

The protrusion accommodating part 15 is depressed to accommodate the protrusion 25 when the external cover 20 is installed on the top of the base 10.

The slot 17 is formed in a pattern enabling the protrusion 25, having been accommodated into the protrusion accommodating part 15, to rotatingly slide into the slot 17. In other words, the external cover 20 is pressed with a predetermined force to rotatingly slide about a center point of the surface of the external cover 20 to insert the protrusion 25, which has been accommodated in the protrusion accommodating part 15, into the slot 17. Accordingly, the protrusion 25 is prevented from deviating from the slot 17. Also, a predetermined pressing force required to be applied to insert the protrusion 25 into the slot 17 by a user is low and can be accomplished easily by most users.

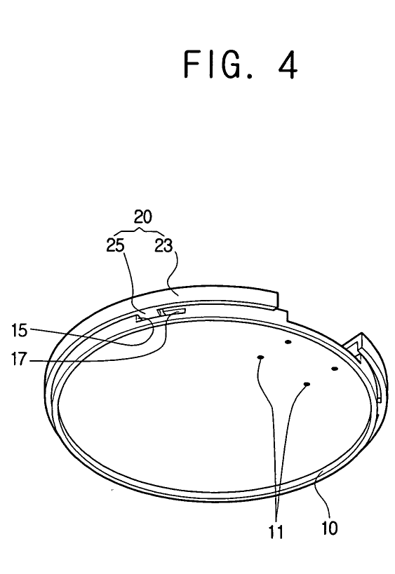

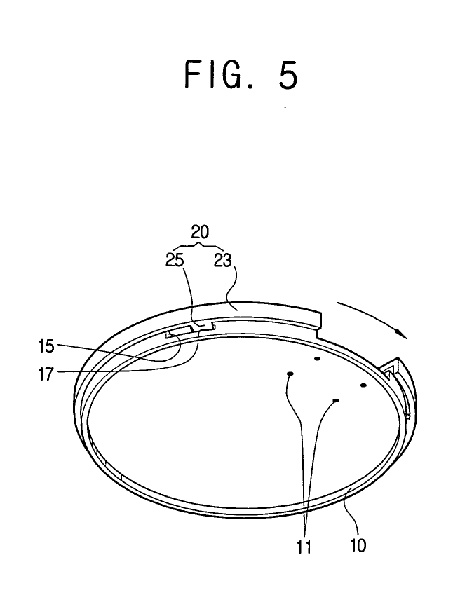

Hereinbelow, according to the above configuration, a process of installing the external cover 20 of the display apparatus according to the first embodiment of the present invention will be described in reference to FIGS. 4 and 5.

Firstly, the protrusion 25 of the external cover 20 is accommodated into the protrusion accommodating part 15 of the base 10. The protrusion 25 is inserted into the slot 17 by rotating the external cover 20.

Meanwhile, a description of a process of detaching the external cover 20 will be skipped because the external cover 20 can be detached through a process having an order reversed to the order of the process of installing the external cover 20.

The display apparatus according to the first embodiment of the present invention is advantageous in that the user may choose one out of various designs for the external covers 20 as the external cover 20 is selectively removable from the base 10. Accordingly, an increase of a price for a product caused by an expense of developing a new design is prevented. Additionally, the present invention provides various appearances according to the user's preference.

Also, the display apparatus according to the first embodiment of the present invention has an advantage that the external cover 20 can be removed easily from the base 10 with the protrusion 25 and the protrusion combining part 13.

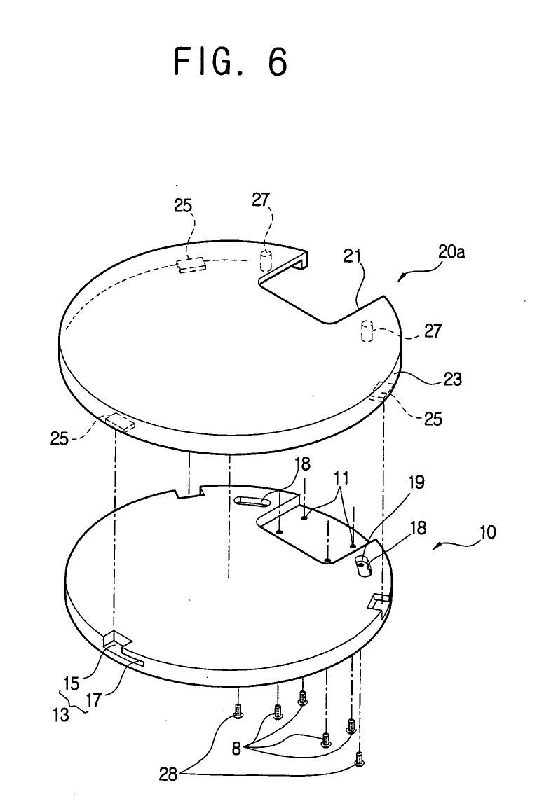

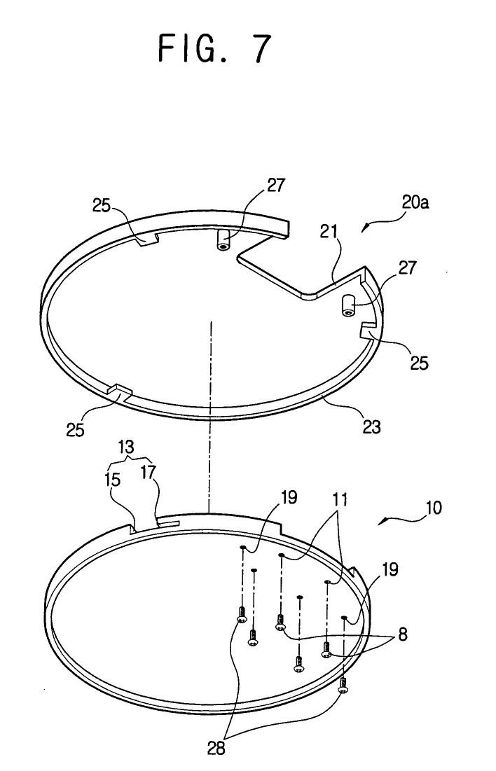

FIGS. 6 and 7 are exploded perspective views of a display apparatus according to a second embodiment of the present invention. As illustrated in FIGS. 6 and 7, a difference between the first embodiment and the second embodiment of the present invention is that the second embodiment is provided with a boss 27 on a rear of the external cover 20a to be screw-combined with the base 10.

The boss 27 may be plural in number and is provided on the rear of the external cover 20a, while the base 10 is provided with a boss accommodating part 18 formed to corresponding to a position(s) of the boss 27. A combining hole 19, through which the boss 27 and the screw 28 combine with each other, is formed on the boss accommodating part 18.

According to the above configuration, to install the external cover 20a of the display apparatus according to the second embodiment of the present invention to the base 10, the boss 27 on the external cover 20a is combined with the screw 28 through the combining hole 19 of the base 10 after the protrusion 25 of the external cover 20a is inserted into the slot 17 of the base 10.

In the above embodiments of the present invention, the protrusion is provided on the external cover while the protrusion combining part is provided on the base 10, however, a protrusion may be provided on the base 10 with a protrusion combining part provided on the external cover 20a.

Also, in the above embodiments of the present invention, the external cover is made of material containing aluminum. However, it may be made of material containing plastic or different metal.

Although a few embodiments of the present invention have been shown and described, it would be appreciated by those skilled in the art that changes may be made in this embodiment without departing from the principles and spirit of the invention, the scope of which is defined in the claims and their equivalents.

1. A display apparatus having a display body forming a picture, comprising:
a base supporting the display body;
a stand provided between the display body and the base; and
an external cover provided to be removable selectively on a top of the base; and
a protrusion provided on at least one of the base and the external cover, and a protrusion combining part to combine with the protrusion provided on the other one of the external cover and the base.

2. The display apparatus according to claim 1, wherein:
the base is shaped like a disk, and
the external cover is shaped like the base to cover up the top of the base.

3. The display apparatus according to claim 2, wherein the external cover comprises a skirt, bent from an edge of the surface of the external cover, to cover at least a part of a side of the base.

4. The display apparatus according to claim 3, wherein the protrusion is formed on the skirt of the external cover toward the base; and
wherein the protrusion combining part comprises:
a protrusion accommodating part depressed on an edge of the base to accommodate the protrusion and
a slot provided on a side of the protrusion accommodating part to prevent the protrusion accommodated in the protrusion accommodating part from deviating by slidingly inserting the protrusion into the slot.

5. The display apparatus according to claim 4, wherein the protrusion and the protrusion combining part each are plural in number and are spaced from each other.

6. The display apparatus according to claim 1, further comprising a rear of the external cover, wherein the rear of the external cover comprises a boss to combine with the base by a screw.

7. The display apparatus according to claim 1, wherein the external cover is made of material containing aluminum.

8. The display apparatus according to claim 4, wherein the protrusion is formed on the skirt of the external cover and faces toward the base.

9. The display apparatus according to claim 8, wherein the protrusion protrudes from an end of the skirt toward a center of the external cover with a predetermined length.

10. The display apparatus according to claim 9, further comprising a slot of the protrusion combining part, wherein the predetermined length is set to be long enough for the protrusion not to deviate from the slot of the protrusion combining part once the protrusion is inserted.

11. The display apparatus according to claim 1, wherein the protrusion and the protrusion combining part are assembled by rotating the external cover such that the protrusion and the protrusion combining part cooperate with each other once the external cover and the base are brought together.
